(19) United States
(12) Patent Application Publication
(10) Pub. No.: US 2009/0190762 A1
(43) Pub. Date: Jul. 30, 2009

(54) METHOD AND SYSTEM FOR PREVENTING GENERATION OF DECRYPTION KEYS VIA SAMPLE GATHERING

(76) Inventor: Andrew Dellow, Minchinhampton (GB)

Correspondence Address: MCANDREWS HELD & MALLOY, LTD, 500 WEST MADISON STREET, SUITE 3400, CHICAGO, IL, 60661, US

(21) Appl. No.: 12/022,609

(22) Filed: Jan. 30, 2008

(51) Int. Cl. H04L 9/28; H04L 9/00

(52) U.S. Cl. 380/277; 380/28

(57) ABSTRACT

Methods and systems for preventing generation of decryption keys via statistical sample gathering may include verifying a one-key message authentication code (OMAC) decryption key in received data and inserting a delay time before subsequent OMAC verifications upon a failure of the verifying. The delay time may be increased, doubled, for example, with each failure of the subsequent OMAC verifications. The cryptographic system may be disabled upon reaching a defined number of OMAC verification failures. The delay time may be reset upon an OMAC verification pass. A number of OMAC verification failures may be stored in non-volatile memory. The OMAC verification may be one of a plurality of key verifications in a key ladder system. A service provider may be required to reset the cryptographic system when the cryptographic system may be disabled due to multiple OMAC failures. The received data may be AES, DES or 3-DES encrypted.

### CROSS-REFERENCE TO RELATED APPLICATIONS/INCORPORATION BY REFERENCE

[Not Applicable]

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to data security. More specifically, certain embodiments of the invention relate to a method and system for preventing generation of decryption keys via statistical sample gathering.

### BACKGROUND OF THE INVENTION

A typical set-top box is a device that processes analog and/or digital information bearing media content. Set-top boxes (STB) may act as a gateway between a television or PC and a telephone, satellite, terrestrial or cable feed for incoming and/or outgoing signals. The STB may receive encoded and/or compressed digital signals from the signal source such as satellite, TV station, cable network, a telephone company, for example, and decodes and/or decompresses those signals, converting them into analog signals displayable on a television. The STB accepts commands from the user (often via use of handheld remote control, keypad, voice recognition unit or keyboard) and transmits these commands back to the network operator.

The implementation of fee-based video broadcasting requires a conventional conditional access (CA) system to prevent non-subscribers and unauthorized users from receiving signal broadcasts. Cryptography algorithms may be utilized, for example, in content protection in digital set-top box systems and in other systems utilized in fee-based video broadcasting. Security keys may, therefore, play a significant part in the encryption and/or decryption process initiated by a cryptography algorithm. For each cryptography algorithm used in a fee-based video broadcasting system, there may be a set of associated security keys that may be needed by the algorithm.

In an increasingly security conscious world, protecting access to information and/or to systems from unwanted discovery and/or corruption is a major issue for both consumers and businesses. Many consumer or business systems may be vulnerable to unwanted access when the level of security provided within the system is not sufficient for providing the appropriate protection. In this regard, consumer systems, such as multimedia systems, for example, may require the use of integrated architectures that enable security management mechanisms for defining and administering user rights or privileges in order to provide the necessary protection from unwanted access. An example of a multimedia system that may be accessed by many different users may be a set-top box where manufacturers, vendors, operators, and/or home users may have an interest in accessing or restricting at least some limited functionality of the system.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for preventing generation of decryption keys via statistical sample gathering, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram illustrating an exemplary head-end system, in accordance with an embodiment of the invention.

FIG. 1B is a block diagram illustrating an exemplary set-top box with a hacker attempting statistical sample gathering, in accordance with an embodiment of the invention.

FIG. 2 is a block diagram illustrating secure key unwrapping in a key ladder system, in accordance with an embodiment of the invention.

FIG. 3 is a block diagram illustrating an exemplary OMAC verification implementation, in accordance with an embodiment of the invention.

### DETAILED DESCRIPTION OF THE INVENTION

Certain aspects of the invention may be found in a method and system for preventing generation of decryption keys via statistical sample gathering. Exemplary aspects of the invention may comprise verifying a one-key message authentication code (OMAC) decryption key in received data and inserting a delay time before subsequent OMAC verifications upon a failure of the verifying. The delay time may be increased, doubled, for example, with each failure of the subsequent OMAC verifications. The cryptographic system may be disabled upon reaching a defined number of OMAC verification failures. The delay time may be reset upon an OMAC verification pass. A number of OMAC verification failures may be stored in non-volatile memory. The OMAC verification may be one of a plurality of key verifications in a key ladder system. A service provider may be required to reset the cryptographic system when the cryptographic system may be disabled due to multiple OMAC failures. The received data may be AES, DES or 3-DES encrypted.

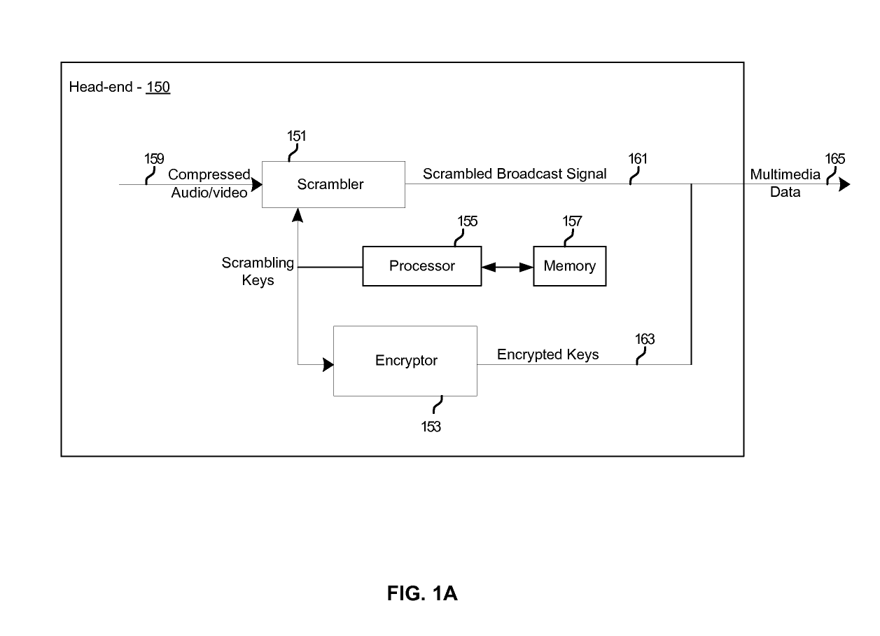

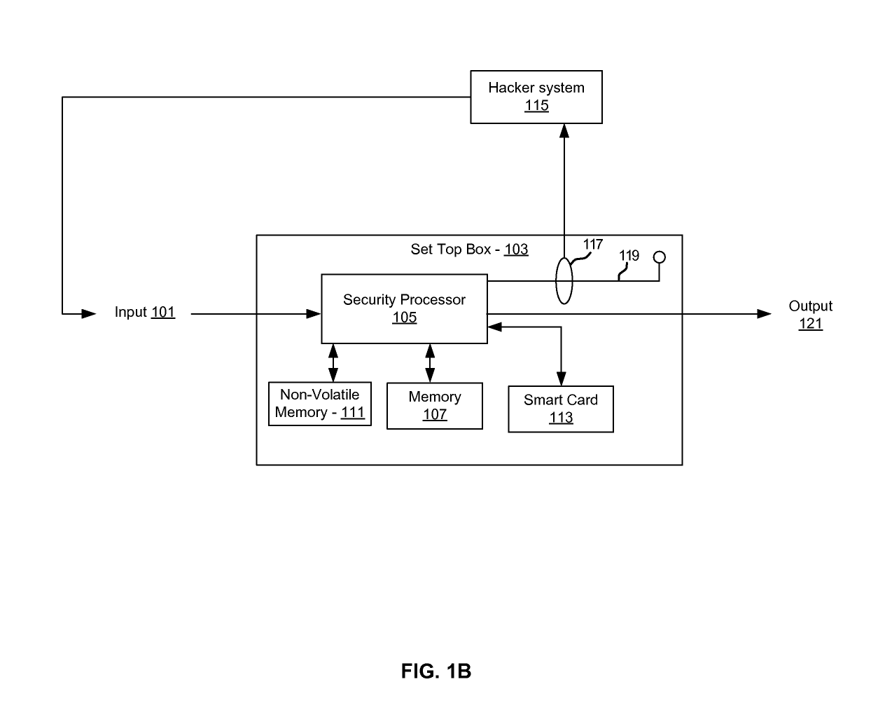

FIG. 1A is a block diagram illustrating an exemplary head-end system, in accordance with an embodiment of the invention. Referring to FIG. 1A, there is shown a block diagram of an exemplary head-end 150 comprising a scrambler 151, an encryptor 153, a processor 155 and a memory 157. There is also shown compressed audio/video 159, a scrambled broadcast signal 161, encrypted keys 163 and a scrambled multimedia signal 165.

The memory 157 may comprise suitable circuitry, logic and/or code that may be enabled to store data that may be utilized by the processor 155 to control the scrambler 151 and the encryptor 153. The data stored on the memory 157 may be utilized by the processor 155 to generate scrambling keys for the scrambler 151 and the encryptor 153.

The scrambler 151 may comprise suitable circuitry, logic and/or code that may be enabled to scramble the compressed audio/video 159 utilizing scrambling keys generated by the processor 155 to generate the scrambled broadcast signal 161. The scrambling keys may be unique to a specific end user, or set-top box, and may be changed periodically to increase security.

The encryptor 153 may comprise suitable circuitry, logic and/or code that may be enabled to encrypt the scrambling keys to generate the encrypted keys 163. The encrypted keys 163 and the scrambled broadcast signal 161 may comprise the multimedia data 165 communicated to an end user, or set-top box.

The processor 155 may comprise suitable circuitry, logic and/or code that may be enabled to generate scrambling keys that may be utilized by the scrambler 151 and the encryptor 153 to generate a scrambled multimedia signal 165.

In operation, during signal scrambling in the head-end 150, the scrambling keys may determine the scrambling pattern and may be communicated to the scrambler 151 and the encryptor 153 by the processor 155. The scrambler 151 may copy protect scramble or conditional access scramble the compressed audio/video 159. The compressed audio/video 159 may be scrambled utilizing encryption standards such as data encryption standard (DES), advanced encryption standard (AES), triple-data encryption standard (3-DES), electronic codebook (ECB), cipher-block chaining (CBC), counter (CTR), cryptomeria cipher (C2), Windows media digital rights management (WMDRM), Rivest Cipher 4 (RC4), message authentication code (MAC) and M6 ciphers (M6S and M6k), for example. The scrambled multimedia signal 165 may be communicated to set-top boxes, for example, for decryption and display.

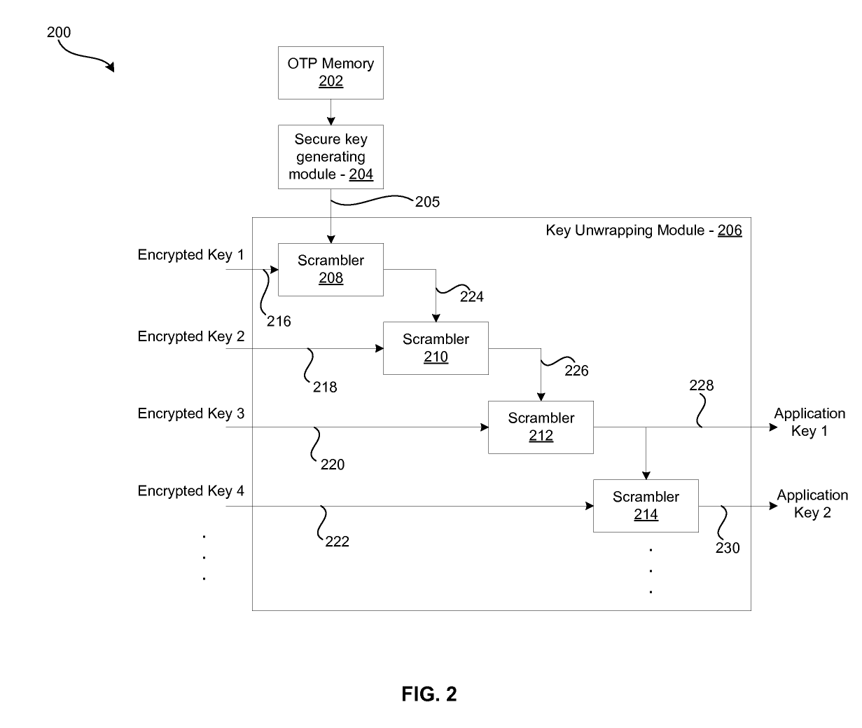

Hackers may attempt to gain access to set-top boxes to learn decrypting keys allowing them to illegally obtain content. A one-key message authentication code (OMAC) may be utilized in set-top boxes to thwart attacks from attackers. An OMAC may comprise a variation of the cipher block chaining message authentication code (CBC MAC) and allows for the secure transmission of messages of any bit length. However, by performing power analysis on components, also known as statistical sample gathering as described further with respect to FIG. 1B, a hacker may detect a system's response to a number of known inputs to determine decryption keys. In an embodiment of the invention, decryption key generation through statistical sample gathering may be prevented by incorporating an increasing delay time after each unsuccessful OMAC verification, and is described further with respect to FIG. 1B and FIG. 2B.

FIG. 1B is a block diagram illustrating an exemplary set-top box with a hacker attempting statistical sample gathering, in accordance with an embodiment of the invention. Referring to FIG. 1B, there is shown a hacker system 115 coupled to a sensing coil 117 and set-top box 103 comprising a security processor 105, a memory 107, a smart card 113, a non-volatile memory (NVM) 111 and a power/signal line 119. There is also shown an input signal 101 and an output signal 121.

The smart card 113 may comprise suitable circuitry, logic and/or code that may be enabled to store and/or decrypt encrypted keys or control words to be utilized by the security processor 105.

The hacker system 115 may comprise a digital storage oscilloscope and a signal generator, for example, that may be enabled to perform statistical sample gathering of the set-top box 103. The sensing coil 117 may comprise suitable circuitry, logic and/or code that may be enabled to sense changes in power usage, of the set-top box 103, and more specifically, the security processor 105, by sensing current through the power/signal line 119. Hackers may also attempt to learn operational characteristics of the set-top box 103 and/or the security processor 105 by sensing emitted electromagnetic radiation, by thermal imaging of set-top box electronics utilizing infrared sensor arrays, or by sensing currents in any information-carrying line or channel in the set-top box 103. In this manner, a hacker may attempt to determine a decryption key by observing the response of the security processor 105 to multiple input signals.

The memory 107 may comprise suitable circuitry, logic and/or code that may be enabled to securely store decrypted and/or encrypted data. The memory 107 may comprise dynamic random access memory (DRAM), for example.

The NVM 111 may comprise suitable circuitry, logic and/or code that may be enabled to store code for controlling operation of the set-top box 103. The code stored in the NVM 111 may be loaded by the security processor 105 and written to the memory 107 for execution by the security processor 105. In an embodiment of the invention, the NVM 111 may comprise a one-time programmable (OTP) memory. The NVM 111 may be enabled to store one or more unique secret keys that may be utilized in a ladder structure encryption scheme, described further with respect to FIG. 2.

The security processor 105 may comprise suitable circuitry, logic and/or code that may be enabled to receive a scrambled transport stream and descramble the transport stream for decoding and/or display. The security processor 105 may comprise a plurality of hardware encryption/decryption engines that may be enabled to decrypt incoming data and/or encrypt data to be communicated outside of the set top box 103.

The set-top box 103 may comprise various exemplary functions such as a scrambling/descrambling function, an entitlement control function, and an entitlement management function. The scrambling/descrambling function may be designed to make the program incomprehensible to unauthorized receivers. Scrambling may be applied commonly or separately to the different elementary stream components of a program. For example, the video, audio and data stream components of a TV program may be scrambled in order to make these streams unintelligible. Scrambling may be achieved by applying various scrambling algorithms to the stream components. The scrambling algorithm usually utilizes a descrambling key. Once the signal is received, the descrambling may be achieved by any receiver that holds the descrambling key used by the scrambling algorithm prior to transmission. Scrambling and descrambling operations, in general, may not cause any impairment in the quality of the signals. The descrambling key used by the scrambling algorithm may be a secret parameter known only by the scrambler and the authorized descrambler or descramblers. In order to preserve the integrity of the encryption process, the control word may be changed frequently in order to avoid any exhaustive searches by an unauthorized user, which may be intended to discover the descrambling key.

The set-top box 103 may be enabled to scramble and/or randomize transmitted data bits so that unauthorized decoders may not decode the transmitted data bits. In addition to scrambling, a key may also be transformed into an encrypted key in order to protect it from any unauthorized users. The set-top box 103 may be enabled to provide protection against signal piracy, efficient scrambling, flexibility, support for a variety of formats, and ease of implementation.

For CA or CP, private (secure) keys may be used for scrambling and descrambling high-value content or for protecting highly sensitive transactions. In a CA system, the content scrambling key may be protected. To ensure proper functionality, the CA system may perform scrambling according to the properties of the data for transmission. In addition, the CA system may be enabled to change the key regularly to maintain the security of the scrambling system, and transmit the key information to the receiver in a secure manner using, for example, a hierarchical encryption system.

In operation, the hacker system 115 may generate a signal, the input signal 101, comprising cyphertext such that when the security processor 105 may attempt to decrypt the received signal, the hacker system may sense the change in power usage via the current in the power/signal line 119 sensed by the sensing coil 117.

In an embodiment of the invention, the security processor 105 may verify OMAC signatures in the input signal 101. In instances when an OMAC signature verification fails, the security processor 105 may require a delay before allowing subsequent attempts at verification. If a subsequent OMAC verification fails, the delay time may double, for example. In instances where a subsequent OMAC verification succeeds, the delay time may decrease back to zero or a defined minimum. In this manner, since multiple verification attempts may be necessary for statistical sample gathering, a hacking operation may quickly become increasingly time consuming and difficult, while legitimate failures, such as from communication or power glitches, may easily be rectified, allowing normal operation of the set-top box 103.

The delay time, or the number of OMAC verification failures, may be stored in memory, such as in the NVM 111, so that even after a power on reset, the security processor 105 may still require a delay before subsequent OMAC signature verifications. Thus, a hacker may not circumvent the delay penalty from an OMAC signature verification failure by simply powering down the set-top box 103 and powering back up.

FIG. 2 is a block diagram illustrating secure key unwrapping in a key ladder system, in accordance with an embodiment of the invention. Referring to FIG. 2, there is shown key ladder system 200 comprising a one time programmable (OTP) memory 202, a secure key generating module 204 and a key unwrapping module 206. The key unwrapping module 206 may comprise scramblers 208, 210, 212 and 214. Each of the scramblers 208, 210, 212 and 214 may utilize a symmetric encryption algorithm, for example a Data Encryption Standard (DES), a 3DES, or an Advanced Encryption Standard (AES) type of algorithm, in order to descramble an encrypted key input. The OTP memory 202 in the key ladder system 200 may be enabled to store a root key. The root key stored in the OTP memory 202 may be further protected by the secure key-generating module 204. The secure key-generating module 204 may comprise suitable circuitry, logic and/or code that may be enabled to scramble, or otherwise further enhance the security of the root key stored in the OTP memory 202.

In operation, the key unwrapping module 206 may be enabled to “unwrap,” or descramble, various application keys, for example, application key 1, 228, and application key 2, 230. In order to achieve this, the key unwrapping module 206 may utilize several encrypted keys, for example, encrypted key 1, 216, encrypted key 2, 218, encrypted key 3, 220, and encrypted key 4, 222. Once the root key stored in the OTP memory 202 may be scrambled by the secure key-generating module 204, the scrambled root key 205 may be utilized by the scrambler 208 in order to decrypt the encrypted key 1, 216, and generate a decrypted key 224. The decrypted key 224 may comprise, for example, a work key. The decrypted key 224 may be utilized by the scrambler 210 in order to decrypt encrypted key 2, 218, and generate the decrypted key 226. The decrypted key 226 may comprise, for example, a scrambling key.

The decrypted key 226 may be utilized by the scrambler 212 in order to decrypt encrypted key 3, 220, and generate the decrypted application key 1, 228. Similarly, the decrypted application key 228 may be utilized by the scrambler 214 in order to decrypt encrypted key 4, 222, and generate the decrypted application key 2, 230. Decrypted application keys 228 and 230 may be further utilized for various functions, for example, for copy protection of broadcast signals. The key ladder in the key unwrapping module 206 may be enabled to have varying levels of protection by increasing the number of the encrypted keys and the corresponding scramblers, and by utilizing each previously decrypted application key in a subsequent decryption of a following encrypted key. The key ladder may be utilized to “unwrap” a master key, a work key and a scrambling key. The master key, work key and scrambling key may then be utilized to decrypt one or more application keys.

In an embodiment of the invention, secret keys stored in the OTP memory 202 may be utilized to decrypt intermediate keys, which may then be used to decrypt control words. The control words may be utilized to decrypt the received content. The number of keys is not limited to the number shown in FIG. 2A. Accordingly, any number of keys may be utilized depending on the desired security level and system complexity. The control words may be changed every few seconds and the session keys may be changed every few hours, for example. The time interval over which control words may be changed may be programmable and there may be a default value.

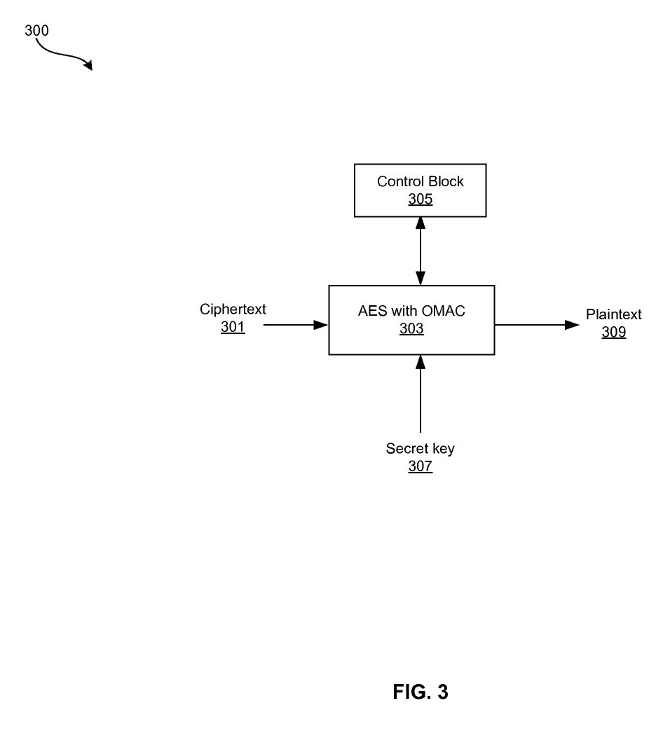

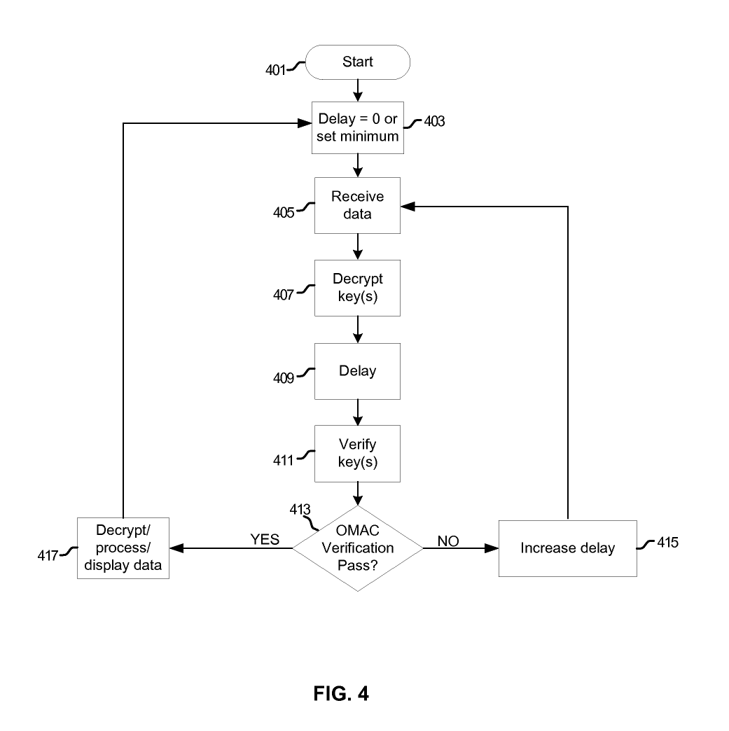

FIG. 3 is a block diagram illustrating an exemplary OMAC verification implementation, in accordance with an embodiment of the invention. Referring to FIG. 3, there is shown an OMAC verification implementation 300 comprising an AES OMAC block 303 a control block 305 and a secret key 307. The AES OMAC block 303 and the control block 305 may reside within the security processor 105 described with respect to FIG. 1B. There is also shown a ciphertext input 301 and a plaintext output 309.

The AES OMAC block 303 may comprise suitable circuitry, logic and/or code that may enable verification of AES encrypted data. The OMAC key may be one of the encrypted keys described with respect to FIG. 2, and as such may be one of a plurality of authentication key verifications.

The control block 305 may comprise suitable circuitry, logic and/or code that may enable controlling of the verification process. The control block 305 may require a delay time between verifications to thwart multiple hacker attempts to determine an OMAC key. The amount of delay may be a programmable value and a default delay may exist.

In operation, in instances where a verification process fails, such as when a hacker may be attempting to perform statistical sample gathering, the control block 305 may impose a delay time before another verification attempt may proceed. In instances where the next verification attempt fails, the delay time may double, which may continue to double with each failure, such that statistical sample gathering becomes increasingly difficult or impossible.

In instances where a legitimate failure may occur, such as from a power or communications glitch, a subsequent OMAC verification pass may reset the delay to zero or a defined minimum. The type of decryption used in the OMAC verification implementation 300 is not limited to AES. The OMAC verification implementation 300 may comprise DES, 3-DES or any desired symmetric or asymmetric key decryption scheme.

In another embodiment of the invention, after a defined number of verification failures, the control block 305 may disable encryption key verification entirely, such that the set-top box 103 may not function without a reset signal received from a head end provider, for example. The number of verifications failures may be programmable and there may be a default value. Notwithstanding, the invention is not limited to the application of a set-top box, and may be utilized in any cryptographic system where dynamic cryptographic keys are utilized.

FIG. 4 is a flow diagram illustrating an OMAC verification process, in accordance with an embodiment of the invention. Referring to FIG. 4, after start step 401 in step 403, the delay variable may be set to zero or a desired minimum, followed by step 405 where data may be received, from a source such as a head end, for example. In step 407, the one or more keys may be decrypted, followed by step 409 where the process may be delayed. In step 411, the one or more keys may be verified, including the OMAC verification. In step 413, in instances where the OMAC verification fails, the process may proceed to step 415 where the delay may be increased before the process returns to step 405. If the OMAC verification fails again, the delay time may be doubled, for example. If in step 413, the OMAC verification passes, the process may proceed to step 417 where the received data may be decrypted, processed and/or displayed as desired. The process may then proceed to step 403 where the delay is again set to zero or a defined minimum.

In an embodiment of the invention, a method and system are provided for verifying a one-key message authentication code (OMAC) decryption key in received data 101 and inserting a delay time before subsequent OMAC verifications upon a failure of the verifying. The delay time may be increased, doubled, for example, with each failure of the subsequent OMAC verifications. The cryptographic system 103 may be disabled upon reaching a defined number of OMAC verification failures. The delay time may be reset upon an OMAC verification pass. A number of OMAC verification failures may be stored in non-volatile memory 111. The OMAC verification may be one of a plurality of key verifications in a key ladder system 200. A service provider may be required to reset the cryptographic system 103 when the cryptographic system 103 may be disabled due to multiple OMAC failures. The received data may be AES, DES or 3-DES encrypted.

Certain embodiments of the invention may comprise a machine-readable storage having stored thereon, a computer program having at least one code section for preventing generation of decryption keys via statistical sample gathering, the at least one code section being executable by a machine for causing the machine to perform one or more of the steps described herein.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for data security, the method comprising:
in a cryptographic system, verifying a one-key message authentication code (OMAC) decryption key in received data; and
inserting a delay time before subsequent OMAC decryption key verifications upon a failure of said verification.

2. The method according to claim 1, comprising increasing said delay time with each failure of said subsequent OMAC verifications.

3. The method according to claim 1, comprising doubling said delay time with each failure of said subsequent OMAC verifications.

4. The method according to claim 1, comprising disabling said cryptographic system upon reaching a defined number of OMAC verification failures.

5. The method according to claim 1, comprising resetting said delay time upon an OMAC verification pass.

6. The method according to claim 1, comprising storing a number of OMAC verification failures in non-volatile memory.

7. The method according to claim 1, wherein said OMAC verification is one of a plurality of key verifications in a key ladder system.

8. The method according to claim 1, comprising requiring a service provider to reset said cryptographic system when said cryptographic system is disabled due to multiple OMAC failures.

9. The method according to claim 1, wherein said received data is AES encrypted.

10. The method according to claim 1, wherein said received data is DES encrypted.

11. The method according to claim 1, wherein said received data is 3-DES encrypted.

12. The method according to claim 1, wherein said delay time before said subsequent OMAC decryption key verifications is programmable.

13. A system for data communication, the system comprising:
one or more circuits in a cryptographic system that verify a one-key message authentication code (OMAC) decryption key in received data; and
said one or more circuits insert a delay time before subsequent OMAC verifications upon a failure of said verifying.

14. The system according to claim 13, wherein said one or more circuits increase said delay time with each failure of said subsequent OMAC verifications.

15. The system according to claim 13, wherein said one or more circuits double said delay time with each failure of said subsequent OMAC verifications.

16. The system according to claim 13, wherein said one or more circuits disable said cryptographic system upon reaching a defined number of OMAC verification failures.

17. The system according to claim 13, wherein said one or more circuits reset said delay time upon an OMAC verification pass.

18. The system according to claim 13, wherein said one or more circuits store a number of OMAC verification failures in non-volatile memory.

19. The system according to claim 13, wherein said OMAC verification is one of a plurality of key verifications in a key ladder system.

20. The system according to claim 13, wherein said one or more circuits require a service provider to reset said cryptographic system when said cryptographic system is disabled due to multiple OMAC failures.

21. The system according to claim 13, wherein said received data is AES encrypted.

22. The system according to claim 13, wherein said received data is DES encrypted.

23. The system according to claim 13, wherein said received data is 3DES encrypted.

24. The system according to claim 13, wherein said delay time before said subsequent OMAC decryption key verifications is programmable.
